(19) United States
(12) Patent Application Publication
(10) Pub. No.: US 2010/0262443 A1
(43) Pub. Date: Oct. 14, 2010

(54) SYSTEMS AND METHODS ASSOCIATED WITH A COLLABORATIVE STRATEGY EDITOR

(76) Inventors: John N. D'Albis, North Easton, MA (US); Albert J. Marcella, Tewksbury, MA (US)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/420,394

(22) Filed: Apr. 8, 2009

(51) Int. Cl. G06Q 10/00; G06F 17/30

(52) U.S. Cl. 705/7; 707/E17.044; 707/E17.005

(57) ABSTRACT

According to some embodiments, a system, method, means, and/or computer program code are provided to facilitate implementation of an enterprise strategy. In some cases, information defining a strategy map is received from users via a graphical user interface collaborative strategy editor. An at least partially structured strategy hierarchy may then be established wherein elements are arranged in multiple levels (e.g., a perspective may be associated with a plurality of objectives and each objective may be associated with a plurality of key performance indicators). Moreover, information associated with the strategy map may be automatically transmitted to a plurality of other users.

### FIELD

Some embodiments of the present invention relate to systems and methods associated with a collaborative strategy editor. In particular, some embodiments relate to systems and methods to establish and/or implement an at least partially structured strategy hierarchy.

### BACKGROUND

An enterprise, such as a business organization, may develop and implement a strategy to improve the performance and results achieved by the enterprise. For example, a company may develop a strategy to increase market share from 10 to 20 percent by improving the quality of a product and adding additional sales people. The process of identifying and creating a strategy in detail can be significant undertaking. Moreover, once a strategy has been defined, the effort to communicate, measure and monitor the implementation of the strategy can be an equally important undertaking. Unfortunately, the two processes are typically often performed as separate, independent efforts by different teams of people using different tools (e.g., word processing, spreadsheet, and presentation applications). In some cases, the strategy may become outdated even before the process of deployment has been completed.

For example, current methods for capturing, refining, and documenting a corporate strategy typically involve numerous executive meetings with strategy consultants. The resulting non-structured documents are then modeled in various ways to communicate with employees, and the strategy is then implemented and deployed using various business applications to measure progress toward strategic goals. As a result, an enterprise might find it is unable to provide the appropriate parties within the enterprise with the reasoning behind the strategy.

Moreover, various elements of an enterprise strategy may change frequently—especially in a relatively large company. For example, the party responsible for implementing or measuring a particular metric related to a strategy might be promoted and replaced by another employee. In this case, finding and updating all of the appropriate strategic documents and reports may be a time consuming and error prone task. In addition, it can be difficult to determine exactly what the strategy was at a particular point in time (e.g., at the end of the last fiscal quarter) and/or why changes were made to an original strategy.

It would therefore be desirable to provide improved methods and systems that facilitate the creation and/or implementation of a collaborative strategy for an enterprise.

### BRIEF DESCRIPTION OF THE DRAWINGS

FIG. 1 is a diagram of a system according to some embodiments of the present invention.

FIG. 2 is a flow diagram of a method for facilitating implementation of an enterprise strategy according to some embodiments of the present invention.

FIG. 3 illustrates a strategy map display according to some embodiments.

FIG. 4 illustrates a strategy map display providing additional information for an according to some embodiments.

FIG. 5 illustrates a high level user display for a collaborative strategy editor according to some embodiments.

FIG. 6 illustrates a perspective level user interface display for a collaborative strategy editor according to some embodiments.

FIG. 7 illustrates an objective level user interface display for a collaborative strategy editor according to some embodiments.

FIG. 8 illustrates a survey definition display according to some embodiments.

FIG. 9 illustrates a key performance indicator level user interface display for a collaborative strategy editor according to some embodiments.

FIG. 10 illustrates a template selection display according to some embodiments.

FIG. 11 illustrates a cascade performance display according to some embodiments.

FIG. 12 illustrates a key performance indicator display according to some embodiments.

FIG. 13 is a block diagram of a system architecture according to some embodiments of the present invention.

FIG. 14 is a block diagram of an apparatus in accordance with some embodiments of the present invention.

FIG. 15 is a flow diagram of a method for facilitating implementation of an enterprise strategy in accordance with some embodiments.

### DETAILED DESCRIPTION

To alleviate problems inherent in the prior art, some embodiments of the present invention introduce systems, methods, computer program code and/or means to establish and/or implement an at least partially structured “strategy” hierarchy. As used herein, the term “strategy” may refer to any set of elements used by an enterprise to reach one or more goals. By way of example only, a “balanced scorecard” is one popular approach used to visualize and report on the progress toward strategic goals.

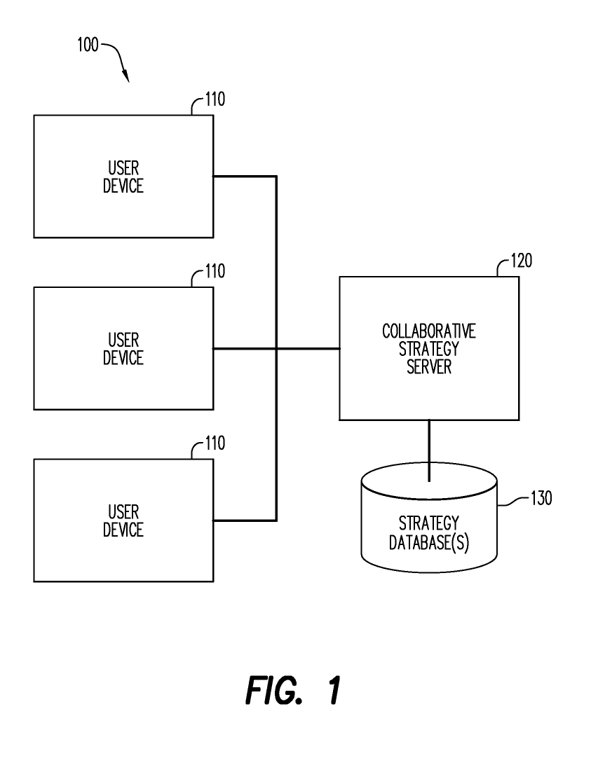

FIG. 1 is a diagram of a system 100 according to some embodiments of the present invention. The system 100 includes a number of user devices 110, such as personal computers, workstations, or mobile devices. The user device 110 may, for example, execute a browser program that receives information from a remote collaborative strategy server 120. The remote collaborative strategy server 120 might, for example, retrieve strategy information from one or more strategy databases 130 and transmit the information to the user device 110 via the Internet or an Intranet.

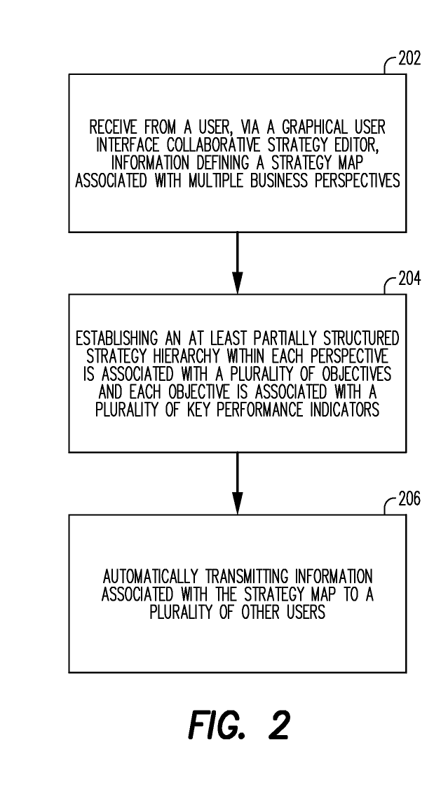

To facilitate the creation and/or implementation of an at least partially structured strategy hierarchy, the system 100 may implement a method such as one illustrated in FIG. 2. The flow charts described herein do not necessarily imply a fixed order to the actions, and embodiments may be performed in any order that is practicable. Note that any of the methods described herein may be performed by hardware, software (including low level language code), or any combination of these approaches. For example, a storage medium may store thereon instructions that when executed by a machine result in performance according to any of the embodiments described herein.

At 202, information defining an enterprise “strategy map” associated with multiple business perspectives may be received from a user. The enterprise might be associated with at, by way of example only, an educational institution, a health care provider, or a governmental agency. The strategy map may represent any structured set of information designed to help the enterprise reach one or more goals, including the types of maps described by Robert Kaplan and David Norton in “The Strategy-focused Organization: How Balanced Scorecard Companies Thrive in the New Business Environment” (Harvard Business School Press, 2001). For example, the collaborative strategy server 120 might receive information associated with a “customer” perspective, a “financial” perspective, a “process” perspective, and/or a “skills” perspective from a user via a graphical user interface collaborative strategy editor (e.g., interfacing with the user at a user device 110).

According to some embodiments, receiving information defining the strategy map is performed by providing to the user a list of available strategy map “templates.” For example, each template might have pre-defined perspectives and relationships between those perspectives. In this case, the user might indicate a selected strategy map template and then provide adjustments to the selected strategy map template (e.g., by adding a new perspective or filling-in objectives for an already existing perspective). According to some embodiments, a user may be allowed to create one or more custom templates.

At 204, an at least partially structured multi-level strategy hierarchy may be established. For example, the strategy hierarchy may include perspective elements wherein each perspective is associated with a plurality of objectives and each objective is, in turn, associated with a plurality of key performance indicators. As used herein, a strategy “objective” might refer to, for example, a goal or state that an enterprise wishes to achieve. Moreover, a “key performance indicator” might refer to, for example, a metric (e.g., a financial or non-financial metric) that measures progress toward an enterprise objective.

At 206, information associated with the strategy map may be automatically transmitted to a plurality of other users. For example, employees of an organization might receive information about objectives and/or key performance indicators that are directly related to their roles within the enterprise (e.g., employees in a sale department might receive information about sales goals but not about quality assurance metrics).

According to some embodiments, adjustments made to a business perspective, an objective, and/or a key performance indicator, may be automatically flowed through the strategy hierarchy. For example, if a key performance indicator is modified (e.g., to represent average provide over the last month instead of the last quarter), that change may be cascaded to all objectives and/or perspectives using that particular key performance indicator. As another example, a user might provide a comment about an objective and that comment might be displayed and/or transmitted to other users as appropriate.

In addition, according to some embodiments, a responsible party may be assigned to a business perspective, an objective, and/or a key performance indicator. Note that the responsible party might indicate a particular person (e.g., employee Bill Jones or ID Number 101212) or a particular position (e.g., head of the marketing department). Moreover, the automatic transmitting of information associated with the strategy map might be based at least in part on the responsible party. For example, a change to a strategy objective might be automatically transmitted to parties responsible for key performance indicators associated with that objective. In some cases, an adjustment associated with a responsible party might be automatically flowed through the strategy hierarchy. For example, if the phone number of a responsible party is modified, the new phone number might be automatically updated throughout the strategy map.

According to some embodiments, changes to the strategy hierarchy may be tracked and stored in an update log. For example, the update log might store an indication associated with who made each adjustment along with a date and time of day the adjustment was made. This may, for example, help a collaborative strategy server re-create how a strategy map was arranged on a particular date (e.g., the beginning of the last financial year).

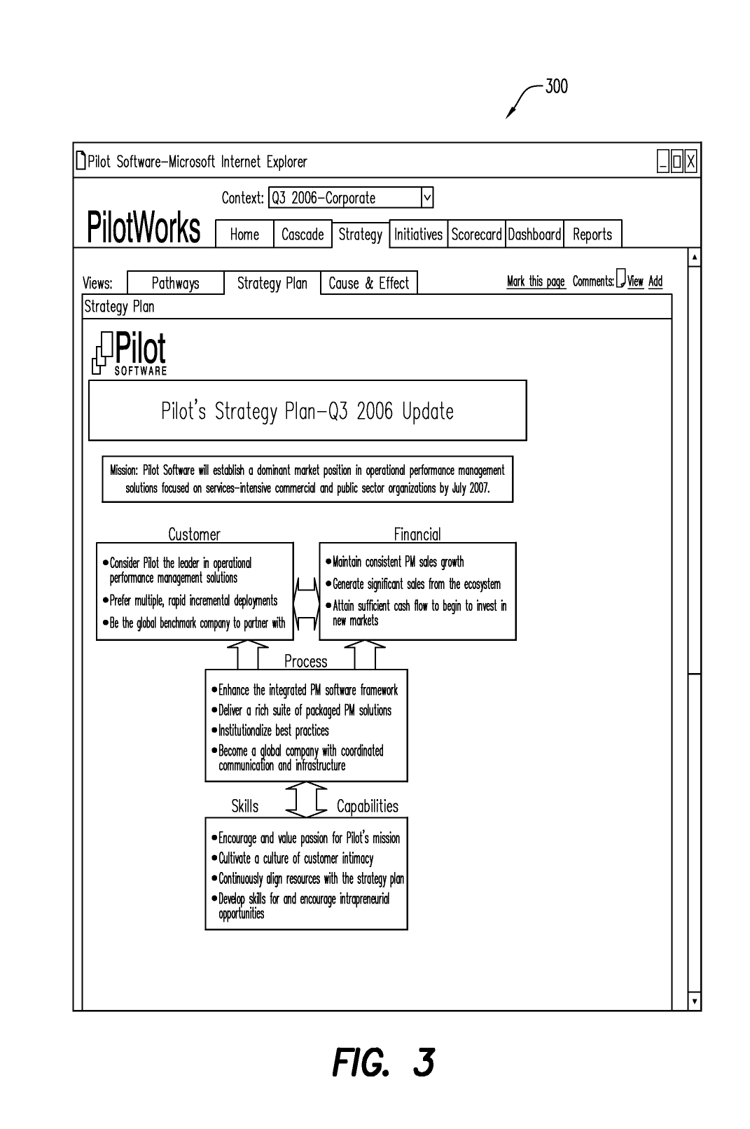

Note that strategy information might be received from and/or displayed to users in any number or different ways, including via various user interfaces. Some examples and descriptions of displays that may be associated with embodiments of the present invention will now be described with respect to FIGS. 3 through 12.

For example, FIG. 3 illustrates a strategy map display 300 according to some embodiments. The display might be used, for example, to help users define, collaborate on refinements, and eventually deploy a strategy map for an enterprise. Note that various levels of information related to the strategy may exist in a natural hierarchy. For example, a strategy “mission” (e.g., an overall goal of an enterprise) might be viewed from a number of different business “perspectives” (such as customer, financial, process and skills/capabilities points-of-view as illustrated in the display 300), and various objectives may support each perspective.

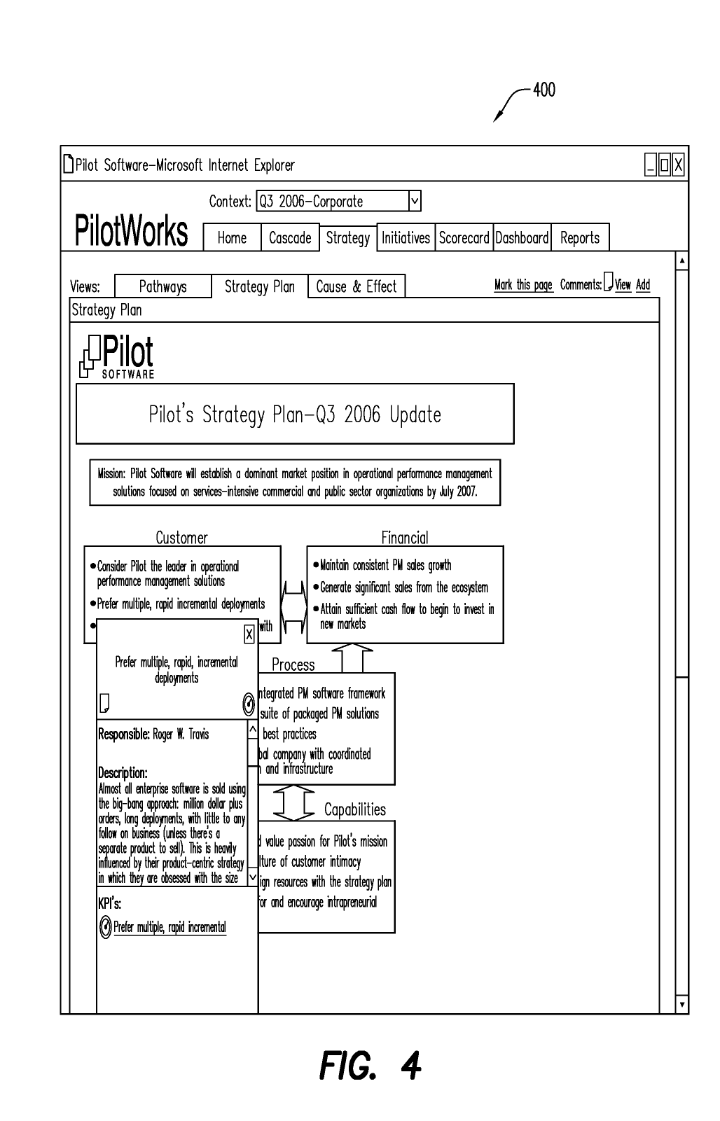

According to some embodiments, additional text explaining each objective may be viewed by clicking on the objective as shown by the display 400 of FIG. 4. In particular, the customer perspective includes an objective (“prefer multiple, rapid incremental deployments”) that has been selected in the display 400. As a result, the display 400 provides additional information, including a responsible party, a further description, and one or more key performance indicators associated with that particular objective.

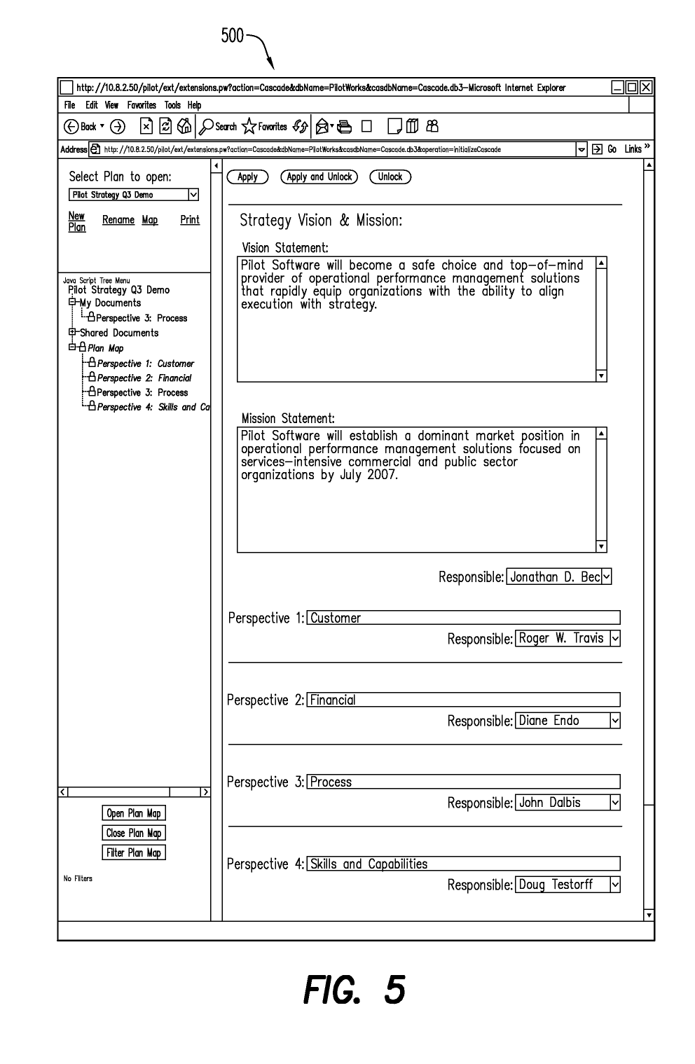

According to some embodiments, a collaborative strategy editor may let one or more users define perspectives for the overall enterprise vision or mission. For example, FIG. 5 illustrates a high level user interface display 500 for a collaborative strategy editor according to some embodiments. In this display 500, users might enter information about who is responsible (along with descriptions of) the overall strategy vision/mission and indicate which perspectives are to be associated with the strategy.

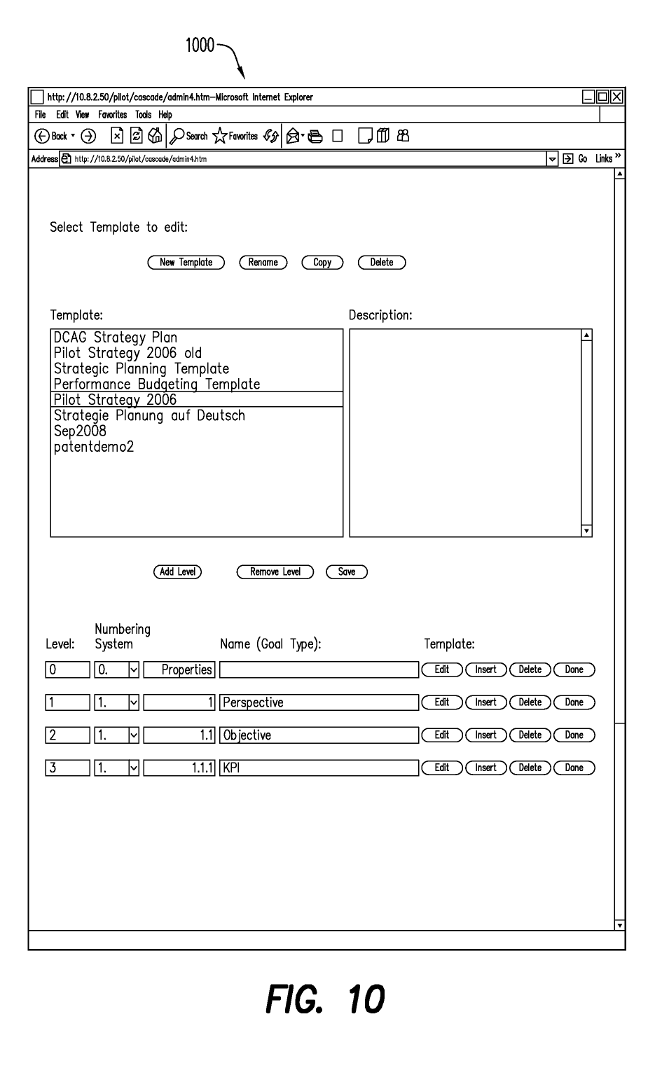

According to some embodiments, a user might begin to define an enterprise strategy by selecting a “new strategy” option and providing a name for the strategy. As a result, a substantially “blank” version of the display 500 of FIG. 5 might be displayed to the user. According to embodiments described in connection with FIG. 10, a user might instead select a strategy template to begin to create an enterprise strategy. According to still other embodiments, a strategy definition “wizard” might ask the user a series of questions to determine some of the strategy information that is provided in the display 500.

The user might interact with the display to provide the vision statement, the mission statement, and a party (from a drop-down list of system generated parties) as the responsible person and click an “add a perspective” icon four times. Note that the “plan map” portion on the left of the display 500 has four perspectives with the first perspective defined as “customer”. These titles may, for example, get auto-generated as the user enters perspective names on the right portion of the display 500.

The action of selecting the user “Roger W. Travis” as a “responsible” party on the lower right portion of the display 500 for “perspective 1”, may assign the perspective “customer” as his responsibility and send an email to Roger telling him he has a workflow item to perform. Likewise, the financial Perspective may be assigned to Diane Endo and she receives an email with a similar task.

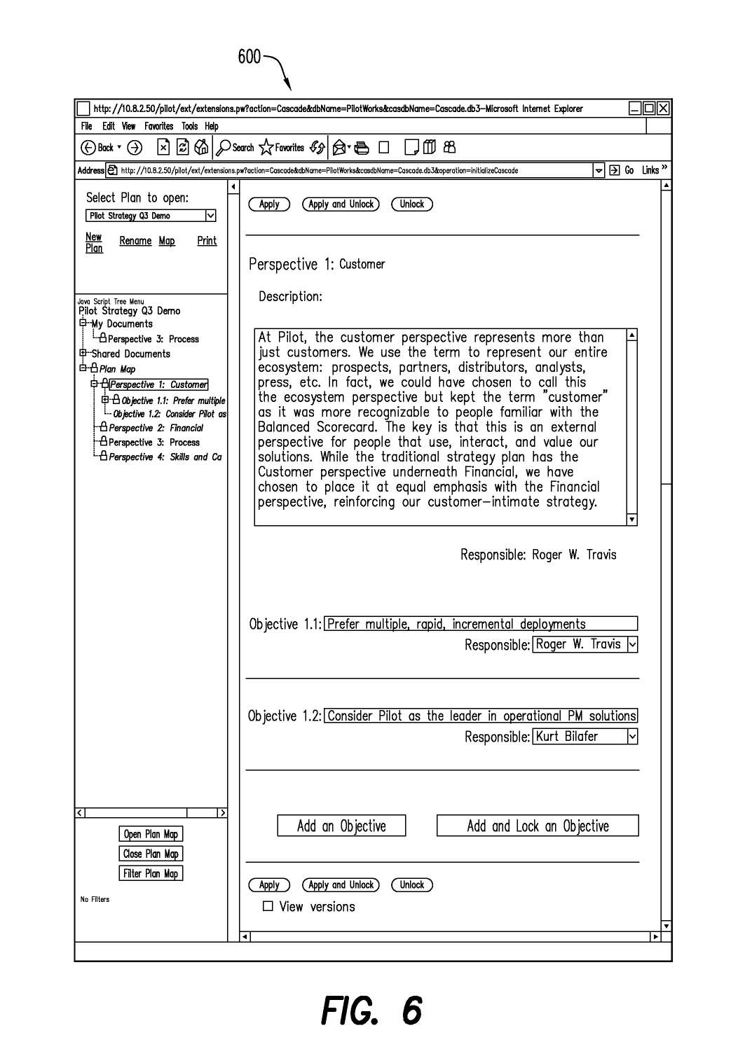

When Roger clicks on his email link, he may be brought to a blank entry screen for the “customer perspective.” For example, FIG. 6 illustrates a perspective level user interface display 600 for a collaborative strategy editor according to some embodiments. Roger may enter a description for the customer perspective and create or more objectives to support the customer perspective. In this example, the “My Documents” tree-item on the upper left portion of the display 600 shows the list of tasks for which you have action items. Note that the user might only see the tasks currently assigned to him (e.g., “Perspective 3: Process” in the example of FIG. 6).

According to some embodiments, the nodes of the plan map displayed in the left panel of the display 600 may be color coded to provide additional information to a user. For example, green nodes may indicate those that are assigned to this user or are locked and being worked on by this user. Orange nodes may indicate someone else is working on that node and has it currently locked. By hovering the mouse over a lock icon, a fly-by may appear showing the person who is currently working on that item. Moreover, according to some embodiments, bolded items in the plan map represent nodes that have new changes (that this user has not yet reviewed). According to some embodiments, the perspective title (“customer”) and responsible party for the perspective might not be editable from this display 600. This may be because these elements are only edited at the parent node associated with the display 500 of FIG. 5.

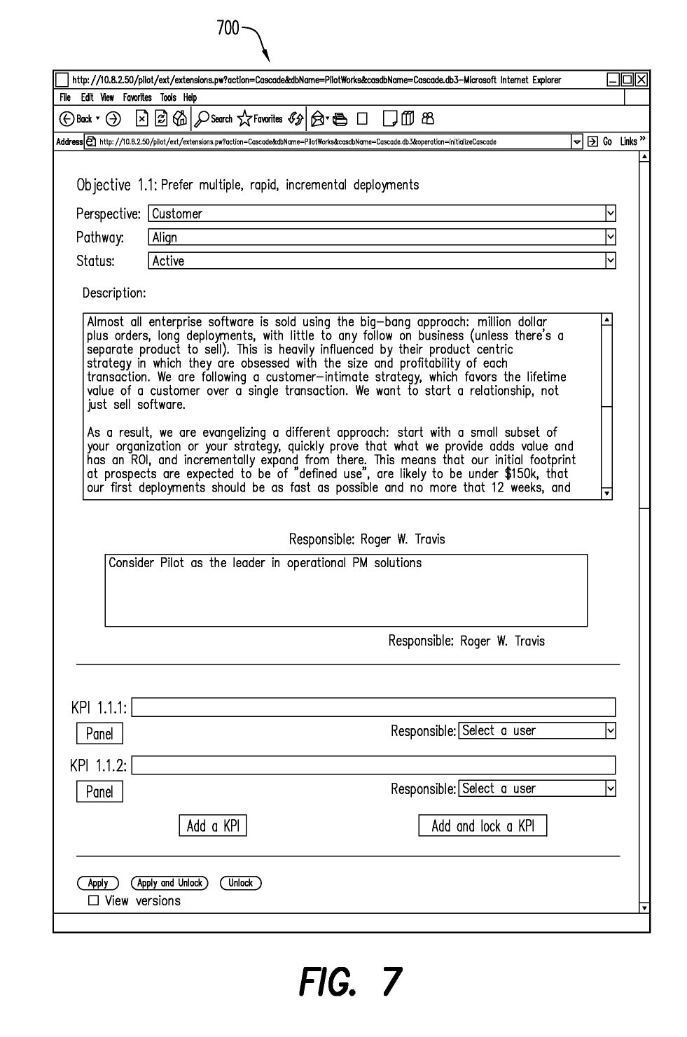

Now Roger defines objective 1.1 (“prefer multiple rapid . . . ”) and assigns himself as the responsible party using the lower right portion of the display 600. As a result, Roger receives an email telling him he was assigned the Objective 1.1 and may, according to some embodiments, click on a link in that email to view an initial screen for that objective. For example, FIG. 7 illustrates an objective level user interface display 700 for a collaborative strategy editor according to some embodiments.

According to some embodiments, the objective title (“prefer multiple, rapid . . . ”) and responsible party for the object might not be editable from this display 700. This may be because these elements are only edited at the parent node, the “perspective 1: customer” of FIG. 6. Note that information describing an objective may be associated with both non-structured data as well as data linkages to related concepts in a strategy model. In some cases, the objective may be described in the context of a “pathway” that tracks objectives as they come into and out of priority as time passes. In the example of FIG. 7, the objective numbered 1.1 is associated with the pathway “align”, and is currently flagged as “active”.

To generate a dependency graph of this objective, we may identify other objectives that “prefer multiple, rapid, incremental deployments” affects. These might be presented to the user, for example, in an “affected objectives” portion of the display 700.

Further note that the display 700 may let a user define one or more key performance indicators (e.g., numbered 1.1.1 and 1.1.2 in the figure) which measure and/or track the progress of this objective.

Returning to the current example, as the party responsible for the objective Roger may fill in an objective description, assign an appropriate pathway and status, and create two key performance indicators (and assign responsible parties as appropriate). For example, for the first key performance indicator Roger may want to create a qualitative key performance indicator based on a survey done by a panel of individuals. In this case, he may click on the “panel” icon.

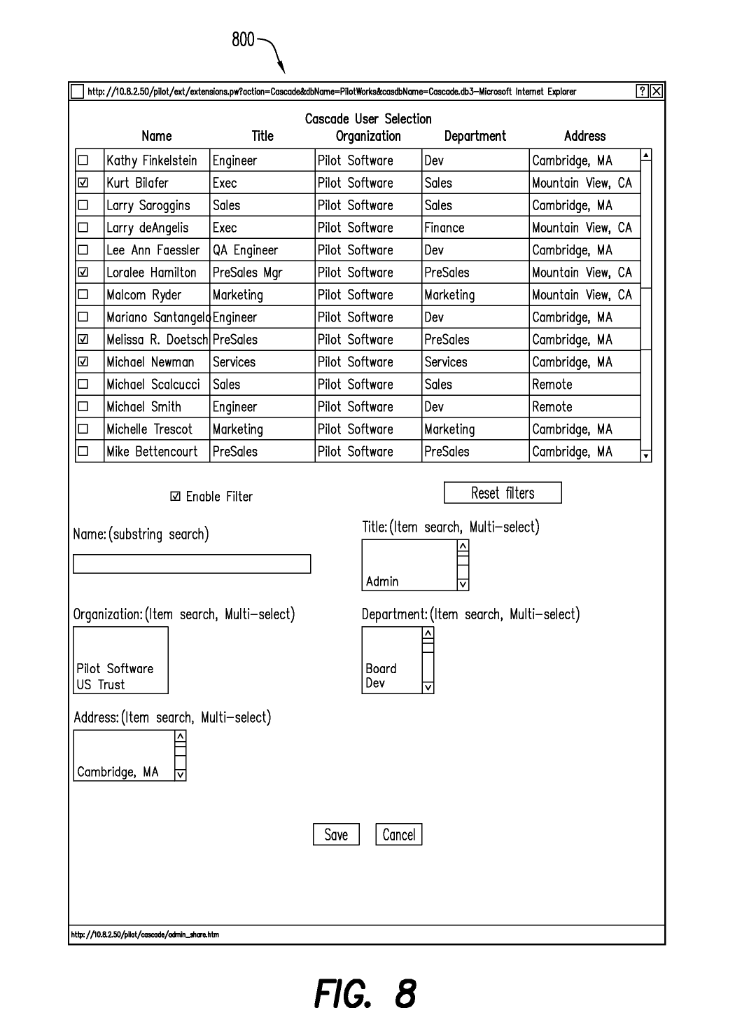

FIG. 8 illustrates a survey definition display 800 according to some embodiments. Using this display, Roger may selects the users who will participate in the survey associated with the key performance indicator. For example, each selected user might be automatically polled on a period basis and asked to grade or otherwise rate a service being performed by an enterprise.

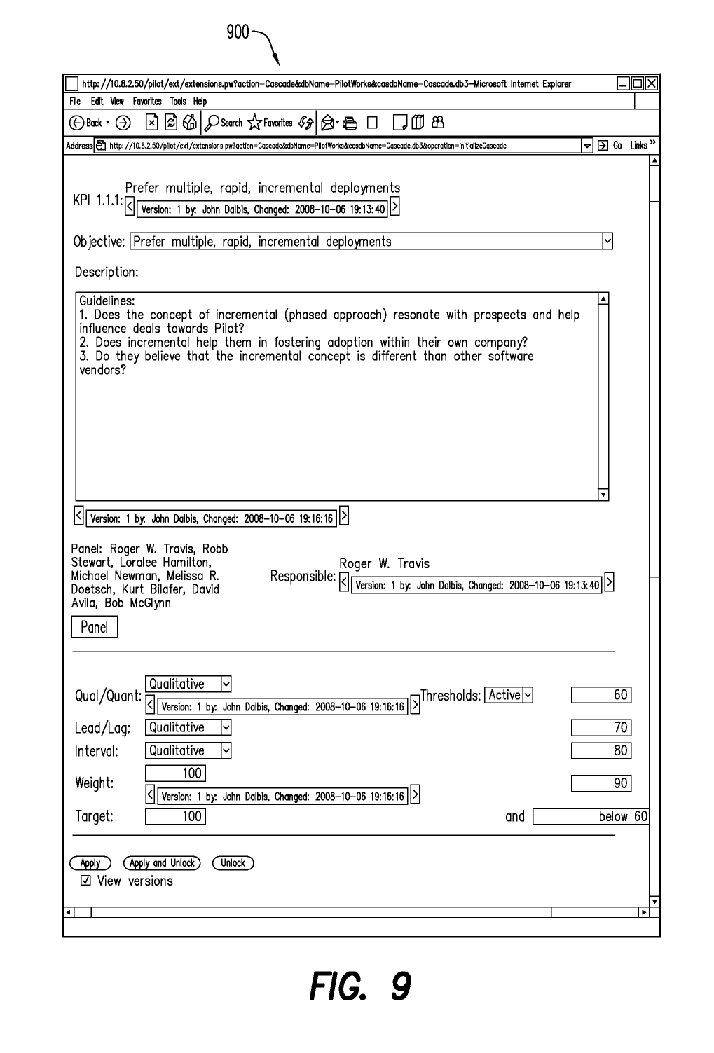

Referring again to FIG. 7, Roger may select the child he assigned to himself (key performance indicator 1.1.1), and another display may be provided. For example, FIG. 9 illustrates a key performance indicator level user interface display 900 for a collaborative strategy editor according to some embodiments. Using the display, Roger may fill in the description and apply any changes. Clicking on the “view versions” selection might, for example, display when the last changes were made (e.g., in accordance with information stored in a log database) along with who made the changes.

In some cases, a user may create a strategy map by defining each and every perspective, objective, and key performance indicator (as well as by indicating how all of those elements relate to each other). According to some embodiments, however, a set of pre-defined strategy templates may be provided for a user. For example, a template may include a set of perspectives and relationships between the perspectives. The user may then select a template as a starting point for his or her enterprise strategy. FIG. 10 illustrates a template selection display 1000 according to some embodiments. The display 1000 may be used, for example, to define a template for other users and/or to select a template to be used to create an enterprise strategy. According to some embodiments, a template may include two parts plus a section for style sheets and headers. The edit windows for the parts might comprise, for example, a what-you-see-is-what-you-get editor that allows a user to drag and drop HyperText Markup Language (HTML) from any browser. The data entry fields may, in some embodiments, be parsed out and/or given tags (or can be assigned user tags).

According to some embodiments, there may be overall strategy templates, perspective level templates, objective level templates, and/or key performance level templates. For example, a perspective level template may include a option to be display with a number of child elements and/or a parent element. A template may also have special variables (e.g., % cas.section.levelname % and % cas.section.number %) imbedded in the text. These variables may then be substituted at runtime with the appropriate text (e.g., a title of “Perspective 1: Customer”).

From the end-user's perspective, this may be seen in the rendering of the initial screen. The title “Perspective 1: Customer” and the responsible person may be taken from a child template, while the vision, mission and overall responsible party may be are rendered from the overall enterprise strategy component. Note that when viewed from the perspective level editor, the title may not be editable. Instead, the title might be shown with higher level template and be edited from that context.

Using HTML templates to collect non-structured data may permit flexibility in the design of data collection capabilities. For example, templates may be constructed in accordance with US Government Performance Results Act (GPRA) requirements.

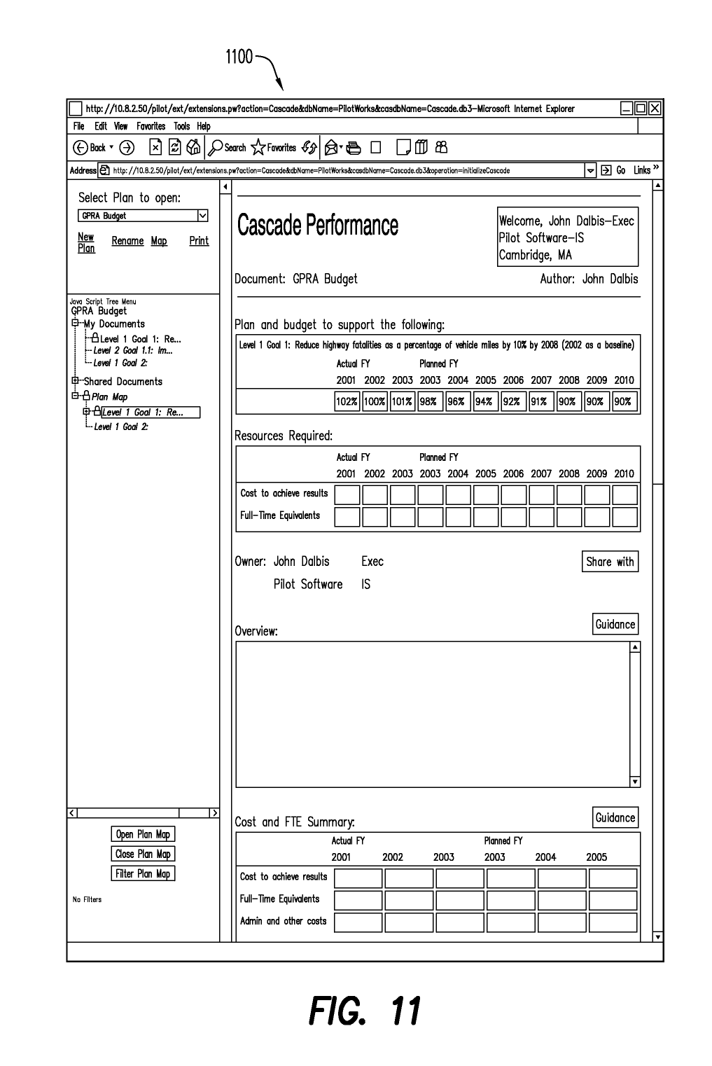

According to some embodiments, an adjustment, associated with any of a business perspective, an objective, or a key performance indicator, is automatically flowed through the strategy hierarchy. For example, if a title of an objective is changed, the new title will be displayed for all perspectives and/or key performance indicators associated with that objective. FIG. 11 illustrates a cascade performance display 1100 according to some embodiments. In this embodiment, performance information may be entered (e.g., associated with performance results, financial costs, and/or man hours) and then be flowed through an enterprise strategy map as appropriate.

According to some embodiments, enterprise strategy information may be output from a collaborative editor. For example, a PDF document might be created or HTML information might be transmitted to another application (e.g., associated with a business information database).

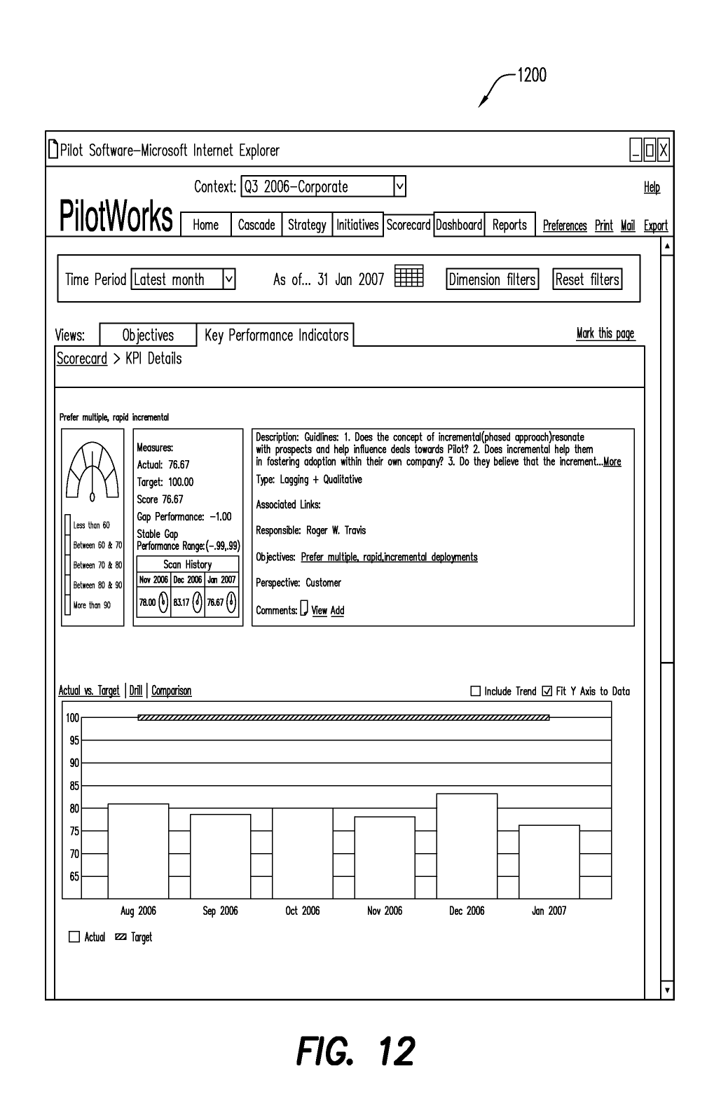

Similarly, according to some embodiments enterprise strategy information may be received by the collaborative editor. For example, key performance indicator information may be received from an external application in substantially real-time (e.g., from a business information warehouse) and then be displayed to the appropriate users (e.g., responsible parties). FIG. 12 illustrates a key performance indicator display 1200 according to some embodiments. In this example, actual and target survey results may be displayed, for example, on graphical chart, scoreboard, dashboard, and/or numerical report.

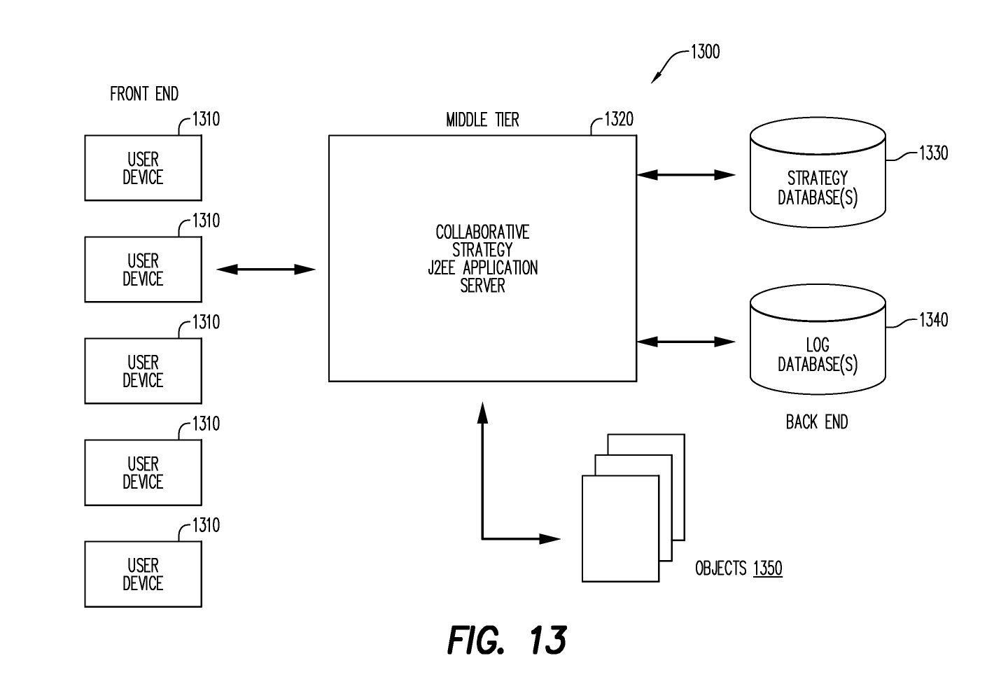

A collaborative strategy editor may be implemented in a number of different ways, for example, FIG. 13 is a block diagram of a system architecture 1300 according to some embodiments of the present invention. In this case, a number of user devices 1310 may exchange information with a remote collaborative strategy J2EE application server 1320 via a communication network. The user devices 1310 might be, for example, front-end PCs executing a browser application to exchange information via the Internet or an intranet. The collaborative strategy J2EE application server 1320 might be associated with a “middle tier” of the system 1300 and may, according to some embodiments, use SQLite3 databases 1330, 1340 as a back-end data storage components. Although a java server 1320 is used herein as an example, note that other types of servers may also be used, including .Net servers and On-Line Analytical Processing (OLAP) servers.

The strategy database 1330 might store, for example, tables associated with enterprise strategy maps and/or templates. The log database 1340 may, for example, store information about changes that have been made to enterprise strategy maps and/or templates (e.g., to let the server 1320 re-construct a strategy map as of a particular date). The server 1320 may also, according to some embodiments, output objects 1350 such as reports, pdf documents, electronic messages and/or presentation materials. The objects 1350 may be output, according to some embodiments, to a strategy management application adapted to publish strategy information, automatically monitor strategy information, automatically capture strategy information, facilitate refining of strategy information, and/or facilitate documentation of strategy information.

According to some embodiments, the architecture 1300 may serve both administrators and end-users. The administrators may, for example, be responsible for designing the layout of the dynamic webforms for collecting the necessary data elements and for defining the basic workflow. Together, this hierarchy of interlinked webforms and selected workflow may be treated by the system 1300 as templates and administrators may assign each template a name.

A strategy plan may thus consist of a hierarchical set of webforms that represent each level in the hierarchy. For example, a level 0 webform may maintain “properties” for the strategy plan and capture information for the plan mission and vision. Level 1 webforms may collect information related to “perspectives”, level 2 webforms may have information for objectives, and level 3 webforms may gather key performance indicator data.

An administrator may decide if there are a fixed number of levels in the system 1300 or if subsequent levels simply repeat the lowest defined level. In the examples of FIGS. 3 through 12, there may be four levels including the properties level.

An “edit” button on an administrator's display may bring up a template editor with the contents of Level 0. Using the template editor, the administrator may define groupings of HTML within parts and assign the parts attributes (e.g., “ZOrder”, “Show with (# of levels of) Children”, “Not Visible” or “Show with Parent”).

When a webform is rendered for an end user at a user device 1310, a query may retrieve the HTML that renders the webform. Additional parts from an ancestor or child node in the hierarchy can appear within the current webform. This behavior may be flagged, for example, by an attribute “Show with (# of levels of) Children”. For example, if the administrator wishes a title from the properties level to also appear on the objective level webform, but not at the key performance indicator level webform, he or she may specify “Show with 2 Children”. An attribute entitled “Show with Parent” may inform parent nodes to include elements from their immediate children. A ZOrder attribute might, according to some embodiments, specify a relative location for a part to appear on the page and may be helpful when combining elements from ancestors and children.

Such an approach may reduce the complexity required for rendering a webpage. Note that a substantial portion of the logic for assembling page elements may be performed at the SQL layer. According to some embodiments, performance may be further enhanced by minimizing the need to manipulate returned record row sets. Note that detailed template information may be saved in one or more system tables. For example, a master template table might include a name, a number of levels, an optional description, and a unique system generated number identifying the template type).

Another table might contain information related to all administrator defined templates. For example, a TemplateID column in the table may contain a system generated unique identifier for each record. Level and part entries may identify the groupings as defined by the administrator for a particular template. A piece entry may represent the result of HTML parsing by the system that extracts user-input elements from the HTML before it is saved in the table. Modifiers may hold any attributes of a user-input TagType element. According to some embodiments, VarName is an optional tag that can be used for variable substitution. For example, the embedded string “% mission %” anywhere in the HTML may be replaced by the server 1320 at run-time with the current text that has been entered for the enterprise strategy. Still another table may store administrator defined level names for the various levels used in templates in the system.

By way of example, one of the first actions a user might perform is to create a new strategy plan. Creating a new plan might result in a call to a makeCASTbls( ) function that adds a record to a CAS_Master table. Upon record creation, the system may generate a new ID number and this ID can be subsequently used to create several plan tables that are prefixed with CAS_<ID>_(where <ID> is the generated ID number). Such an approach may, for example, reduce a size of plan tables for improved performance using SQLite3.

According to some embodiments, a CAS_<ID>_Template table may be created and populated with a copy of the template records from a CAS_TemplateTbl table. This might be done, for example, to take a snapshot of the template records in case an administrator makes later changes to the master templates. It may also improve performance when later joining against this table by minimizing its size.

Then a CAS_<ID>_Levels table may be created and one record may be inserted to create a top level “Properties” node (this starting record may, for example, have a LevelID=1). Each record in this table may correspond to a node in the strategy plan that can be identified by concatenating L1, L2, and L# . . . columns to determine its location in the hierarchy. The starting record may represent the top of the hierarchy (e.g., it may represent the special case 0.0.0).

A new hierarchy node in the strategy plan may be created whenever a record is added to the table. Views can later combine data from the CAS_<ID>_Template, the CAS_<ID>_Levels and CAS_<ID>_Doc tables to assemble webforms to be presented to an end-user. For example, a node “Objective 1.1: Prefer multiple rapid, incremental deployments” may be represented by LevelID=6 in a Levels plan table (e.g., L1.L2.L3 may equal 1.1.0 where trailing 0.0's are truncated.)

Another plan table that may be used to build a view, such as a CAS_<ID>_Doc table, may be created and left empty. As users enter data, data records may be appended, and time-stamped, along with user entered data. According to some embodiments, records are not deleted so the full history can always be extracted and examined.

Data entry may occur from this point in a Levels table as new nodes are created, and in a DOC table as data is entered by users. Data “querying” may happen through views that are provided to user. For example, a first view may perform a self-join on the CAS_<ID>_Doc table to return only the most recent user entered data. A second view, CAS_<ID>_DocView, may combine the template records, the level records and the user-entered doc records into one view. A simple query from this view may be used, for example, to retrieve all the HTML to render a webform instance. A third view, similar to the second view, may instead be joined directly against the CAS_<ID>_Doc table to allow access to all user modifications. A purpose of such a view may be, for example, to provide detail by input field to show what was changed at each point in the history of the creation of the strategy plan and to enable a “show versions” option.

By manipulating such views, it may be possible to capture the state of a strategy plan at any point in time. By substituting an alternate view based on a DocLast style view where the selection criteria is instead a.ModVer<“2009-09-01 08:00:00”, it may be possible, for example, to publish the strategy plan as of 8:00 am, Sep. 1, 2009. Note that being able to see what changed (and who changed it) may be important for a collaborative aspect of a strategy editor. Knowing what changed may, for example, be an important step in understanding where and why the strategy is changing.

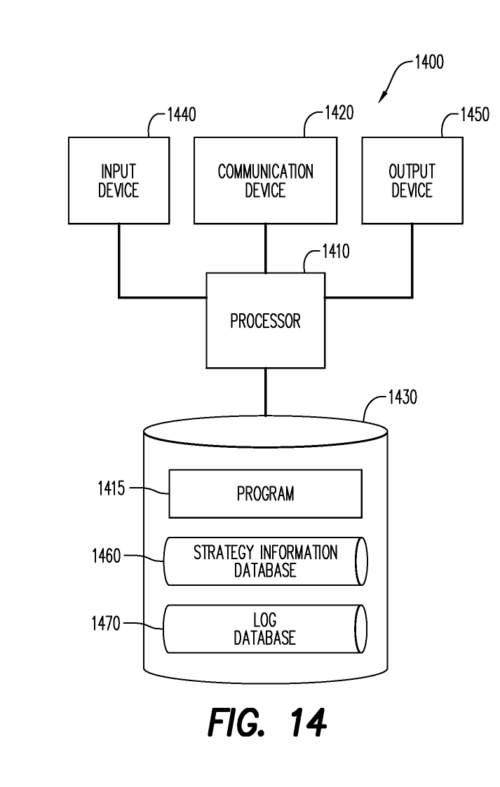

FIG. 14 is a block diagram of an apparatus 1400 in accordance with some embodiments of the present invention. The apparatus 1400 might, for example, execute a process such as the one illustrated in FIG. 2 and/or generate the user displays shown in FIGS. 3 through 12. The apparatus 1400 comprises a processor 1410, such as one or more INTEL® Pentium® processors, coupled to a communication device 1420 configured to communicate via a communication network (not shown in FIG. 14). The communication device 1420 may be used to communicate, for example, with remote user devices via the Internet.

The processor 1410 is also in communication with an input device 1440. The input device 1440 may comprise, for example, a keyboard, a mouse, or computer media reader. Such an input device 1440 may be used, for example, by an administrator to enter strategy templates. The processor 1410 is also in communication with an output device 1450. The output device 1450 may comprise, for example, a display screen or printer. Such an output device 1450 may be used, for example, to provide reports and electronic notifications to administrators.

The processor 1410 is also in communication with a storage device 1430. The storage device 1430 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices.

The storage device 1430 stores a program 1415 for controlling the processor 1410. The processor 1410 performs instructions of the program 1415, and thereby operates in accordance any embodiments of the present invention described herein. For example, the processor 1410 may receive information defining elements of a strategy map associated with multiple business perspectives from various users via a graphical user interface collaborative strategy editor. An at least partially structured multi-level strategy hierarchy may then be established by the processor 1410 (e.g., perspective elements may be associated with a plurality of objective elements and each objective element may in turn be associated with a plurality of key performance indicator elements. Moreover, information associated with the strategy map (including comments about and changes made to the strategy map) may be automatically transmitted through the communication device 1420 to a plurality of remote users.

As used herein, information may be “received” by or “transmitted” to, for example: (i) the apparatus 1400 from other devices; or (ii) a software application or module within the apparatus 1400 from another software application, module, or any other source. As shown in FIG. 14, the storage device 1430 may also store a strategy information database 1460 according to some embodiments. The strategy information database 1460 may, for example, store information about enterprise strategy maps and/or templates. The storage device 1430 may further store a log database 1470 according to some embodiments. The log database 1470 may, for example, store information about who has changed enterprise strategy maps and/or templates (along with an indication of when the adjustments were made).

The illustration and accompanying descriptions of devices and databases presented herein are exemplary, and any number of other arrangements could be employed besides those suggested by the figures. For example, multiple databases associated with different strategy maps and/or map levels might be associated with the apparatus 1400.

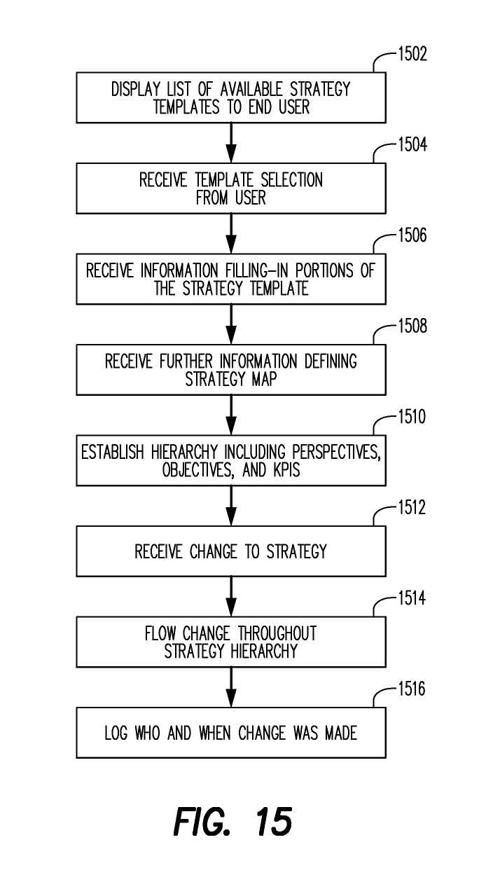

FIG. 15 is a flow diagram of a method for facilitating implementation of an enterprise strategy in accordance with some embodiments. At 1502, a list of available strategy map templates may be displayed to an end user. At 1504, a selected strategy map template may be received from the user (e.g., he or she might click on the name of a template).

At 1506, information may be received from the user filling-in portions of the selected template (e.g., the names of various objectives within a pre-defined perspective). Similarly, at 1508, further information defining a strategy map associated with multiple business perspectives may be received from the end user (e.g., he or she might add additional key performance indicators not included on the selected template).

At 1510, an at least partially structured strategy hierarchy may be established wherein each perspective is associated with a plurality of objectives and each objective is associated with a plurality of key performance indicators. For example, a collaborative strategy editor might create and store such a hierarchy.

At 1512, an adjustment may be received in connection with any of a business perspective, an objective, or a key performance indicator. For example another user might update a description of a strategy perspective. At 1514, the adjustment may be automatically flowed through the strategy hierarchy (e.g., it may be reflected as appropriated in other elements of the hierarchy). At 1516, the adjustment to the enterprise strategy may be logged (e.g., indicating who and when the change was made).

Because an enterprise strategy is always changing, adapting, and/or being refined, some embodiments of the present invention provide an application that not only facilitates the administration and tracking of such changes, but that also enables collaboration, provides version control, and is flexible to the needs of an organization. The collaborative strategy editor described herein may be used in some embodiments to describe and develop corporate strategy, to collaboratively identify and communicate appropriate objectives, to identify and document key performance indicators, to publish key performance indicators for reporting and scorecards, and/or to provide means for tracking and understanding changes to an enterprise strategy.

Note that for a corporate strategy to be most effective, it may need to be coherent and communicated in a meaningful and actionable way to a number of different employees. Moreover, employees at different levels and functions within an organization may best interpret and support the corporate strategy in different ways. For example, a goal such as “increase sales by 10%” may be easily understood by the sales department, but it may be less clear to the customer support organization on how to help achieve this increased sales objectives. Using some embodiments of the present invention, the customer support organization may determine that the best way to support increased sales is by improving customer satisfaction with support thereby leading to repeat customers.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the applications and databases described herein may be combined or stored in separate systems). Similarly, although a particular information flow and user interactions have been given as examples, other and/or additional steps may be performed in accordance with any embodiments described herein. For example, although a particular type of enterprise strategy has been used herein as an example, other formats and strategy approaches might be used instead in accordance with any of the embodiments described herein.

Embodiments described herein may be useful in connection with, by way of example, business enterprise applications (e.g., applications adapted to help track key performance indicators). The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer-readable medium having stored thereon processor-executable instructions, to facilitate implementation of an enterprise strategy, that when executed by a processor result in the following:
receiving from a plurality of users, via a graphical user interface strategy editor, collaborative strategy information associated with elements of a strategy map;
establishing an at least partially structured strategy hierarchy based on the received collaborative strategy information, wherein the elements are arranged in multiple levels of the strategy hierarchy;
receiving from one of the plurality of users additional information associated with the strategy map; and
automatically transmitting information associated with the additional information to a plurality of other users.

2. The medium of claim 1, wherein levels of the strategy hierarchy are associated with at least one of: (i) a business perspective, (ii) an objective, or (iii) a key performance indicator.

3. The medium of claim 1, wherein the additional information is associated with at least one of: (i) an existing element, (ii) an existing level, (iii) a new element, (iv) a new level, (v) a comment, (vi) a workflow, (vii) a task request, or (viii) a task response.

4. The medium of claim 1, wherein execution of the instructions further results in:
publishing information associated with the strategy map.

5. The medium of claim 1, wherein execution of the instructions further results in:
automatically monitoring real-time business information associated with at least one element of the strategy map.

6. The medium of claim 1, wherein the additional information comprises an adjustment that is automatically flowed through the strategy hierarchy.

7. The medium of claim 1, wherein a responsible party is associated with at least one of a business perspective, an objective, or a key performance indicator.

8. The medium of claim 7, wherein said automatic transmitting of information associated with the strategy map is based at least in part on the responsible party.

9. The medium of claim 7, wherein an adjustment associated with a responsible party is automatically flowed through the strategy hierarchy.

10. The medium of claim 1, wherein an update log is maintained to store indications associated with adjustments made to the strategy hierarchy.

11. The medium of claim 10, wherein the update log stores indications associated with (i) a party who made each adjustment, and (ii) a time the adjustment was made.

12. The medium of claim 1, wherein said receiving from the users information defining the strategy map includes:
providing to a first user a list of available strategy map templates;
receiving from the first user a selected strategy map template; and
receiving from the first user adjustments to the selected strategy map template.

13. The medium of claim 1, wherein execution of the instructions further results in:
receiving key performance indicator values in substantially real time.

14. The medium of claim 13, wherein execution of the instructions further results in:
providing a graphical user interface to display the key performance indicator values to a plurality of parties.

15. The medium of claim 1, wherein execution of the instructions further results in:
outputting information to a strategy management application adapted to facilitate at least one of: (i) publishing strategy information, (ii) automatically monitoring strategy information, (iii) automatically capturing strategy information, (iv) refining of strategy information, or (v) documentation of strategy information.

16. A system, comprising:
a back-end database storage element, wherein the back end database storage element is to store (i) information defining a strategy map associated with multiple business perspectives and (ii) an at least partially structured multi-level strategy hierarchy wherein each perspective is associated with a plurality of objectives and each objective is associated with a plurality of key performance indicators;
a middle tier java server coupled to the back-end database storage element, wherein the middle tier server is to (i) automatically transmit information associated with the strategy map to a plurality of users, and (ii) automatically flow through the strategy hierarch a change in a business perspective, an objective, or a key performance indicator; and
a front end element coupled to the middle tier server, wherein the front end element is to receive from one of the plurality of users, via a graphical user interface collaborative strategy editor, adjustments to the strategy map wherein said adjustments are displayed to other users.

17. The system of claim 16, wherein the middle tier server comprises at least one of: (i) a java server, (ii) a .Net server, or (iii) an online analytical processing server.

18. The system of claim 16, wherein the back-end database storage element further stores an update log including indications associated with adjustments made to the strategy map.

19. The system of claim 13, further comprising:
a key performance indicator engine coupled to the middle tier server to receive key performance indicator values in substantially real time,
wherein the middle tier server is further adapted to provide, via the front end element, a graphical user interface displaying the key performance indicator values to a plurality of parties.

20. A method to facilitate implementation of an enterprise strategy, comprising:
receiving from a plurality of users, via a graphical user interface strategy editor, collaborative strategy information associated with elements of a strategy map;
establishing an at least partially structured strategy hierarchy based on the received collaborative strategy information wherein the elements are arranged in multiple levels of the strategy map;
receiving from one of the plurality of users a comment associated with an element of the strategy map; and
automatically transmitting information associated with the comment to a plurality of other users.

21. The method of claim 20, wherein an adjustment, associated with any of a business perspective element, an objective element, or a key performance indicator element, is automatically flowed through the strategy hierarchy.

22. The method of claim 20, wherein a responsible party is associated with at least one of a business perspective element, an objective element, or a key performance indicator element, and further wherein said automatic transmitting of the comment is based at least in part on the responsible party.

23. The method of claim 20, wherein an update log is maintained to store indications associated with adjustments made to the strategy hierarchy, and further wherein the update log stores indications associated with (i) a party who made each adjustment, and (ii) a time the adjustment was made.

24. The method of claim 20, wherein said receiving from the users information defining the strategy map includes:
providing to a first user a list of available strategy map templates;
receiving from the first user a selected strategy map template; and
receiving from the first user adjustments to the selected strategy map template.
